(19) United States
(12) Patent Application Publication
(10) Pub. No.: US 2006/0168172 A1
(43) Pub. Date: Jul. 27, 2006

(54) Obtaining user input for inclusion in system management logs

(75) Inventor: O.R. Senthil Kumaran, Bangalore (IN)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 11/008,443

(22) Filed: Dec. 9, 2004

(51) Int. Cl. G06F 15/173

(52) U.S. Cl. 709/223; 709/224

(57) ABSTRACT

An administrator may enter information related to a system event or system performance directly into systems management software. The systems management software includes at least a portion of the information entered by the administrator in a log, which may be provided to a second administrator using the systems management software. By being able to enter information into the systems management software, the logs generated by the systems management software may be able to include information not normally logged according to the systems management software rule set.

### TECHNICAL FIELD

This disclosure relates generally to systems management software, and more particularly to including user input in logs generated by systems management software.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some such information handling systems use systems management software to provide information about how the information handling system is functioning. Generally, the systems management software is configured to log various hardware events, alerts, commands, etc. In addition to recording these events some implementations of systems management software may also generate various alert messages to notify administrators that a specified event has occurred.

### SUMMARY

In accordance with teachings of the present disclosure, a system, method, and software are described for recording information associated with hardware events, performance, or other system related information. In at least one embodiment, an administrator inputs system information directly into a systems management software application. The information entered by the administrator is recorded in a log by the systems management software, and may be provided to a second administrator via systems management software. At least one such embodiment provides an advantage of not requiring email programs or similar external communications software to be used in conjunction with the systems management software. Some such embodiments permit events falling outside of rules coded into the systems management software, but observed by an administrator, to be recorded in a log.

In addition to generating a log, the systems management software may generate an alert message and provide that alert message to a remote management console, thereby alerting a remote administrator that an event has occurred. The remote administrator, using the systems management software, may view or otherwise retrieve the log to aid in troubleshooting or otherwise evaluating an event. Since the log and/or the alert message may include information entered by an administrator who actually observed the event, the range of events recorded in an event log by the systems management software can be expanded.

Other embodiments include a computer readable medium embodying a program of executable instructions. The program of instructions in at least one such embodiment includes at least one instruction to implement systems management functionality, e.g., generating hardware, alert or command logs according to a rule set, and instructions to obtain system information input from a first administrator. The program of executable instructions further includes an instruction to generate a log, e.g., by generating a new log or appending information to an existing log, that includes at least part of the system information that was obtained from the first administrator. The program of instructions may be used to provide the log generated to another administrator for review or other action.

Yet another embodiment of the disclosure provides an information handling system that includes a processor, memory, and systems management software. The systems management software implements system management functionality, including generating a log that includes at least a portion of information obtained from an administrator. The information obtained from the administrator may include information associated with system performance, events, or similar information that may fall outside of a rule set that instructs the systems management software to automatically generate a system log.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram illustrating a network that includes an information handling system running systems management software according to an embodiment of the present disclosure.

FIG. 2 is a flow diagram illustrating a method of recording system information using systems management software according to an embodiment of the present disclosure.

### DETAILED DESCRIPTION

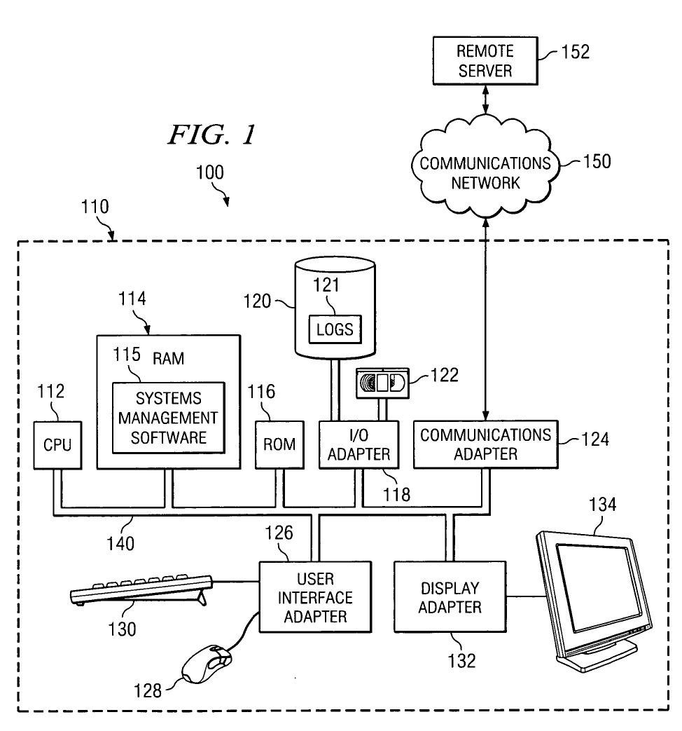

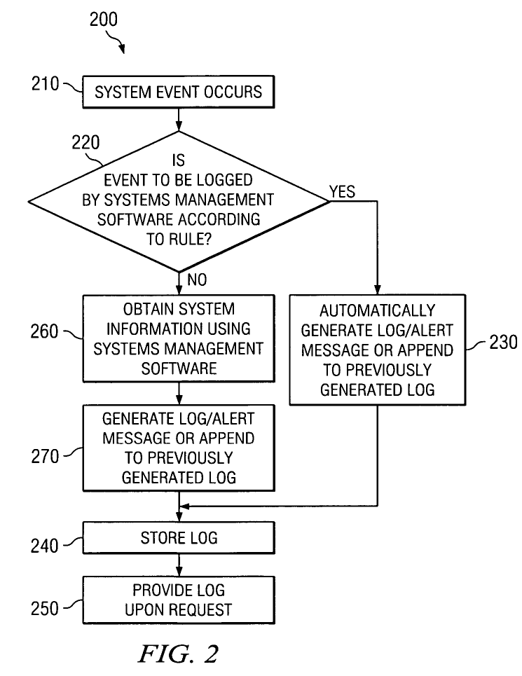

Preferred embodiments and their advantages are best understood by reference to FIGS. 1 through 2, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a network 100 including such an information handling system is illustrated according an embodiment of the present disclosure. Network 100 includes information handling system 110 connected to a remote information handling system, such as remote server 152, via a communications network 150. Communications network 150 may be a wide area network such as the Internet, a local area network such as an intranet, or any other similar network or combination of networks. Such networks may include satellite or other wireless links, landline components such as plain old telephone (POTS) lines, fiber optic channels, intelligent network components, or any other suitable network components or subsystems implementing any of various communication protocols.

Information handling system 110 includes central processing unit (CPU) 112 connected to various subsystems and peripherals via communications bus 140. Also connected to communications bus 140 are random access memory (RAM) 114, read-only memory (ROM) 116, I/O adapter 118, communications adapter 124, display adapter 132 and user interface adapter 126.

RAM 114 may include static dynamic RAM (SD RAM), double data rate RAM (DDR RAM), synchronous-dynamic RAM (SDRAM) or other suitable types of RAM. Generally, RAM 114 holds programs, e.g. systems management software, and data to be executed by CPU 112. ROM 116 may include electrical erasable programmable read-only memories (EEPROM) or other types of non-volatile memories. ROM 116 is generally used to hold basic input/output system (BIOS) instructions used by CPU 112 during power up, or other types of information that may be required to be available to CPU 112 on a non-transitory basis.

In the illustrated embodiment, I/O adapter 118 is shown connected to disk drive 120 and tape drive 122. Disk drive 120 may be, in some embodiments, an electro-magnetic storage medium, such as a hard disk drive, or a collection of disk drives, e.g. a redundant array of independent disks (RAID). Tape drive 122 may be a magnetic storage tape, such as those used for back-up and archival purposes, or some other suitable type of analog or digital tape drive useful for storing information that may be used by CPU 112. Although not illustrated, other types of drives and/or storage devices may be connected to I/O adapter 118. For example, various optical drives, e.g. compact disk (CD) drives, digital video disk (DVD) drives, and the like may also be connected to information handling system 110 through I/O adapter 118 or through a separate I/O adapter configured to control particular storage devices.

User interface 126 may be used to provide connection for various devices, such as mouse 128 and keyboard 130, that allow information handling system 110 to receive input from, and provide input to, an administrator. Note that as used herein, the term “administrator” is not limited to a particular type of user having enhanced file or system access rights compared to other users. Although the term administrator includes such a user, administrator, as used herein, may include any person using information handling system 110, regardless of that person's access classification.

Display adapter 132 is also connected to communications bus 140, and provides video signals or display data to be displayed on display 134. Communications adapter 124 may be an Ethernet adapter, a token ring adapter, a satellite interface digital subscriber link (DSL) adapter, or any of various other communication subsystems adapted to communicate via a network or otherwise.

Although not illustrated in FIG. 1, information handling system 110 may have various sensors, switches, or the like that may be monitored by systems management software 115 resident in RAM 114. Systems management software 115 may also monitor the status of various physical adaptors, software and firmware processes, or the like. By monitoring such events and/or processes, systems management software 115 can provide an administrator with information that may aid in troubleshooting system performance problems, improving systems performance, or the like.

Systems management software 115 may include a set of rules that dictate which software and/or hardware events are to be recorded in logs 121. Logs 121 may include hardware logs, alert logs, command logs, power on self test (POST) logs or the like. Hardware logs, sometimes referred to as Embedded Server Management (ESM) logs or system event logs (SEL) may be used to report actual or potential hardware problems. Alert logs may include information such as sensor status changes, chassis intrusion, and so forth. POST logs are usually employed to record results of POST tests for various hardware components. Command logs may provide details of commands executed from a server's graphical user interface (GUI) or command line interface (CLI).

A particular log, or type of log, may be generated upon the first occurrence of an event specified by the rules by which systems management software 115 operated. Alternatively, log files implementing logs 121 may be created in advance, and systems management software 115 may append information to logs 121 as recordable events occur. It should be noted, that the term “append”, as used in reference to appending information to logs 121, should not be construed in the strictest sense of requiring information to be added only at the end of a log or log file. Instead, at least some embodiments of the present disclosure may add information into logs 121 at some point other than the end of the log. The present disclosure refers to information added at the end of a log, in the middle of the log, or at the beginning of the log, or elsewhere as being appended to the log.

Referring next to FIG. 2, a method according to an embodiment of the present disclosure will be discussed. Method 200 begins at 210, with the occurrence of a system event. A system event may be a hardware, software, firmware, or other similar event, and includes unanticipated events as well as normal operational events. So, for example, a system event may include completion of a power on self test, failure of a peripheral controller to initialize, a change in voltage outside of specified normal operating conditions, fan speed irregularity, completion of a network log on, and so on.

The method proceeds to 220, where the systems management software determines if the event is to be logged based on a systems management software rule set. So, for example, if the systems management software rule set specifies that a temperature outside of a prescribed limit is to be recorded in a system alert log, the method proceeds to 220 where that log is automatically generated. Generating the log may include generating an alert message, and/or appending the logged event to a previously generated log.

After the log is generated at 230 the method proceeds to store the log at 240, for example in a nonvolatile storage medium such as a disk drive, a CD ROM drive, or the like. At some later time, the method proceeds to 250, and the systems management software provides the log upon request by an administrator. Note that in some embodiments, the log may be provided automatically, rather than only upon receipt of a request.

Returning to 220, if the rule set according to which the systems management software is operating does not specify that a log is to be generated for a particular event, the method proceeds to 260. An event not specified for logging could include an observation by an administrator that the performance of an information handling system appears to be less than optimum. Other events may include particular hardware, software, or firmware events that are not included in the rule set of the systems management software due to subsequent hardware upgrades, software upgrades, firmware upgrades. Alternatively, some events may have been intentionally excluded from the system log, possibly because of the quantity of data that would result from reporting such events, or otherwise. Another example of an event that may not be recorded by systems management software includes a system hang, or some other event that prevents the proper operation of the systems management software itself.

If the systems management software rule set does not cause the system event to be logged, systems management software may obtain system information from an administrator at 260. The systems management software may obtain such system information by prompting an administrator for information upon occurrence of an event, or it may obtain the information in response to a request by an administrator to add information to a system management log.

So, for example, if a system hangs, the systems management software may be able to detect the improper shutdown after the system is restarted, but may not be able to automatically determine, e.g., without user input, the reason for the system hang. In such a case, the systems management software may present a text entry area to an administrator automatically, and prompt the administrator to enter any information available regarding the system hang. This information may be presented to the user via a graphical user interface using any of various methods known to those skilled in the art. In other embodiments, the systems management software may not be aware of the system hang, and thus an administrator may initiate entry of data into the systems management software by issuing a log entry request. In response to the request, the systems management software may display a text entry window, screen, menu, entry or other entry mechanism to allow the administrator to enter information related to the system hang. Systems management software, according to at least one embodiment of the present disclosure, provides for an administrator to enter information directly into the systems management software.

After the information is obtained at 260, the method proceeds to 270, where the systems management software generates a log and/or alert message, or appends information to a previously generated log. The log and/or alert message generated at 270 includes at least some of the information that was entered by the administrator at 260. This information may be stored in a separate log of administrator noted events, or included in one or more logs already maintained by the systems management software. By maintaining the administrator's observations as part of the systems management software, other administrators can more easily access a complete record of system events in one place, rather than being required to access multiple different data and/or information sources related to system performance and/or events.

After the log is generated, the log is stored at 240 and may be provided upon request to other administrators at 250. Additionally, as discussed previously with reference to logs automatically generated by systems management software without administrator input, the log may be provided automatically to another administrator.

It should be noted that although some embodiments benefit from other administrators accessing system logs through the same systems management software that generated the logs, various alert messages may be sent using email or other software in conjunction with the systems management software. Thus, for example, the systems management software may generate a log including an administrators observation that the system is running slowly, and that log may be provided to another administrator via an email attachment. Alternatively, a pager, voicemail, or other similar notification may be provided to another administrator.

Although the disclosed embodiments have been described in some detail, it should be understood that various changes, substitutions and alterations can be made to the embodiments without departing from their spirit and scope.

What is claimed is:

1. A method of recording system information using systems management software, the method comprising:
obtaining system information from a first administrator using an input provided by the systems management software;
using the systems management software to generate a log comprising at least a portion of the system information obtained from the first administrator; and
providing the log to a second administrator via the systems management software.

2. The method of claim 1, wherein the system information comprises information not otherwise logged by the systems management software.

3. The method of claim 1, wherein generating a log comprises generating an alert message.

4. The method of claim 1, further comprising providing the log to a remote management console.

5. The method of claim 1, wherein generating a log comprises appending at least a portion of the system information to a previously created log.

6. The method of claim 1, wherein the system information comprises notes associated with performance of an information handling system.

7. A computer readable medium tangibly embodying a program of executable instructions, said program of executable instructions comprising:
at least one instruction executable to implement systems management functionality, wherein systems management functionality comprises generating at least one log to maintain a record of system events according to a rule set;
at least one instruction executable to obtain system information from a first administrator;
at least one instruction executable to generate a log comprising at least a portion of the system information obtained from the first administrator; and
at least one instruction executable to provide the log to a second administrator.

8. The computer readable medium of claim 7, wherein said at least one instruction to obtain system information comprises at least one instruction to obtain information not automatically recorded in accordance with the rule set.

9. The computer readable medium of claim 7, wherein said at least one instruction to generate a log comprises at least one instruction to generate an alert message.

10. The computer readable medium of claim 7, further comprising at least one instruction executable to provide the log to a remote management console.

11. The computer readable medium of claim 7, wherein said at least one instruction to generate a log comprises at least one instruction to append at least a portion of the system information to a previously created log.

12. The computer readable medium of claim 7, wherein the system information comprises notes associated with performance of an information handling system.

13. An information handling system comprising:
a processor;
memory operably coupled to said processor; and
systems management software capable of being stored in said memory and executed by said processor, said systems management software comprising:
at least one instruction to implement systems management functionality, wherein systems management functionality comprises generating at least one event log to maintain a record of system events according to a rule set;
at least one instruction to obtain system information from a first administrator;
at least one instruction to generate a log comprising at least a portion of the system information obtained from the first administrator; and
at least one instruction to provide the log to a second administrator.

14. The information handling system of claim 13, wherein said at least one instruction to obtain system information comprises at least one instruction to obtain information not automatically recorded in accordance with the rule set.

15. The information handling system of claim 13, wherein said at least one instruction to generate a log comprises at least one instruction to generate an alert message.

16. The information handling system of claim 13, further comprising a communications subsystem to provide the log to a remote management console.

17. The information handling system of claim 13, wherein said at least one instruction to generate a log comprises at least one instruction to append at least a portion of the system information to a previously created log.

18. The information handling system of claim 13, wherein the system information comprises notes associated with performance of an information handling system.

19. The information handling system of claim 13, further comprising:
a display screen; and
wherein said at least one instruction to obtain system information from a first administrator comprises at least one instruction to display a user selectable object, said user selectable object selectable to display a text-entry area on the display screen.

20. The information handling system of claim 19, wherein said systems management software includes at least one instruction to obtain system information from an administrator located at a remote information handling system.
